(19) United States
(12) Patent Application Publication
(10) Pub. No.: US 2026/0074502 A1
(43) Pub. Date: Mar. 12, 2026

(54) Locking Plate Splice Connectors

(71) Applicant: Hubbell Incorporated, Shelton, CT (US)

(72) Inventors: Connor Owen Douglas Buckley, Manchester, NH (US); Bradley Steven Elliott, Epping, NH (US); Brian Royal Ellis, Dover, NH (US)

(21) Appl. No.: 19/319,338

(22) Filed: Sep. 4, 2025

Related U.S. Application Data
(60) Provisional application No. 63/691,384, filed on Sep. 6, 2024.

(51) Int. Cl. H02G 15/113

(52) U.S. Cl. CPC H02G 15/113

(57) ABSTRACT

An electrical conductor splice connector includes a first plate including a first pair of channels and an orifice extending through first plate. A second plate includes a second pair of channels and an orifice extending through the second plate. A pin is dimensioned to be friction fit within the orifices extending through the first and second plates.

### CROSS-REFERENCE TO RELATED APPLICATIONS

This application is based on and claims priority to U.S. Provisional Application Ser. No. 63/691,384 filed Sep. 6, 2024, entitled LOCKING PLATE SPLICE CONNECTORS the contents of which are incorporated herein in their entirety by reference.

### TECHNICAL FIELD

The present disclosure relates generally to splice connectors. More particularly, the present disclosure relates to locking plate splice connectors.

### DESCRIPTION OF THE RELATED ART

Splice connectors and assemblies are known in the art. Splice connectors may be adapted to electrically and mechanically connect conductors within a transmission or distribution circuit. For example, a typical splice connector may be used to connect a first conductor to a second conductor. The first and second conductors may be, for example, ground conductors.

Various types of splice connector systems exist including various systems utilizing specialized tools to complete a splice using the splice connector. These tools generally require the use of one or more types of specialized hand tools and/or power tools.

A need exists for splice connectors that can be used in the field and which do not require the use of any types of specialized hand tools and/or power tools.

### SUMMARY

The present disclosure provides exemplary embodiments of electrical conductor splice connectors including a first plate including a first pair of channels and an orifice extending through first plate. A second plate includes a second pair of channels and an orifice extending through the second plate. A pin is dimensioned to be friction fit within the orifices extending through the first and second plates.

The electrical conductor splice connectors are adapted to electrically and mechanically connect conductors. According to another illustrative embodiment of the present disclosure, an electrical conductor splice connector includes matching first and second plates, each including a pair of channels and an orifice extending through the plate. A pin is dimensioned to be friction fit within the orifices extending through the first and second plates.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a perspective view of an electrical conductor splice connector according to an illustrative embodiment of the present disclosure;

FIG. 2 is a front view of the electrical conductor splice connector according to an illustrative embodiment of the present disclosure;

FIG. 3 is a perspective view of the electrical conductor splice connector according to an illustrative embodiment of the present disclosure;

FIG. 4 is another perspective view of the electrical conductor splice connector according to an illustrative embodiment of the present disclosure;

FIG. 5 is a perspective view of a connector plate which forms a portion of the electrical conductor splice connector according to an illustrative embodiment of the present disclosure;

FIG. 6 is a cross-sectional view of the connector plate depicted in FIG. 5, taken along the lines 6-6 of FIG. 5, according to an illustrative embodiment of the present disclosure;

FIG. 7 is a perspective view of the electrical conductor splice connector without conductors installed according to the illustrative embodiment of the present disclosure;

FIG. 8 is an exploded view of the electrical conductor splice connector for describing its use according to an illustrative embodiment of the present disclosure;

FIG. 9 is a perspective view of an electrical conductor splice connector according to another illustrative embodiment of the present disclosure;

FIG. 10 is a front view of the electrical conductor splice connector of FIG. 9 according to an illustrative embodiment of the present disclosure;

FIG. 11 is a perspective view of the electrical conductor splice connector of FIG. 9 according to an illustrative embodiment of the present disclosure;

FIG. 12 is another perspective view of the electrical conductor splice connector of FIG. 9 according to an illustrative embodiment of the present disclosure;

FIG. 13 is a perspective view of a connector plate which forms a portion of the electrical conductor splice connector according to an illustrative embodiment of the present disclosure;

FIG. 14 is a cross-sectional view of the connector plate depicted in FIG. 13, taken along the lines 14-14 of FIG. 13, according to an illustrative embodiment of the present disclosure;

FIG. 14A is a perspective view of a first side or end of the connector plate depicted in FIG. 13 according to an illustrative embodiment of the present disclosure;

FIG. 14B is another perspective view of a second side or end of the connector plate depicted in FIG. 13 according to an illustrative embodiment of the present disclosure;

FIG. 15 is a perspective view of the electrical conductor splice connector of FIG. 9 without the conductors, according to an illustrative embodiment of the present disclosure;

FIGS. 15A and 15B are enlarged views of portions of the electrical conductor splice connector according to an illustrative embodiment of the present disclosure; and

FIG. 16 is an exploded view of the electrical conductor splice connector for describing its use according to an illustrative embodiment of the present disclosure.

### DETAILED DESCRIPTION

The present disclosure provides exemplary embodiments of improved electrical cable splice connectors adapted to electrically and mechanically connect conductors. The electrical cable splice connectors contemplated by the present disclosure electrically and mechanically connect conductors.

For ease of description, the electrical cable splice connectors contemplated by the present disclosure may also be referred to herein as the “connectors” in the plural and the “connector” in the singular. The conductors referenced herein include, for example, ground conductors of various sizes or gauges but may also include transmission line conductors, branch conductors, etc. The conductors or cables referenced herein may include single strand or multi strand cables. The conductors may be encased in an insulating jacket or have one or more insulating coatings which are stripped prior to used in the connectors described herein.

Reference to stripped conductors or cables refers to portions of the conductors or cables not having the insulating jacket or coatings.

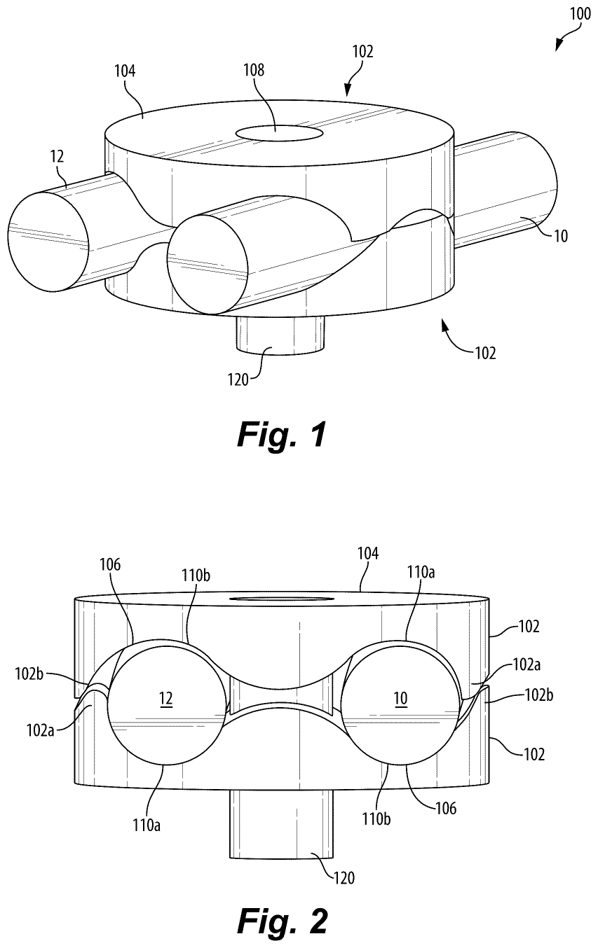

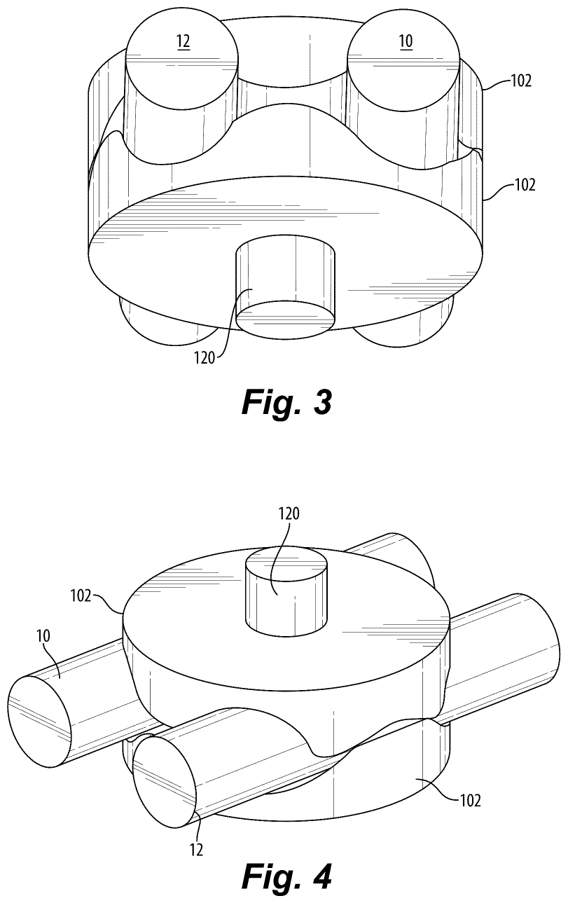

A locking plate splice connector according to an illustrative embodiment of the present disclosure is shown in FIG. 1 and may be referred to generally as cable connector or connector 100. Connector 100 includes substantially similar or identical first and second plates 102 and pin 120 which is friction fit into orifices 108 extending through the first and second plates 102. As will be described greater detail later below, bare cables (e.g., ground cables 10, 12) are positioned between the first and second plates 102 and pin 120 is driven into the orifices 108 compressing the first and second plates 102 against the bare cables 10 and 12 providing a mechanical and electrical connection thereto.

Connector 100 includes first and second plates 102 each having a first surface 104 and a second surface 106. Passages or orifices 108 extend through the centers of the first and second plates 102 and are dimensioned to receive a pin 120. According to an illustrative embodiment of the present disclosure, pin 120 is received in orifices 108 with a friction fit. Pin 120 may be tapered to allow it to be initially positioned within passage or orifice 108. For example, pin 120 may have a slight taper from one end to the other end. Alternatively, each end of pin 120 may be tapered such that the middle portion of pin 120 is slightly larger in diameter than the end portions. Generally, pin 120 has a diameter allowing pin 120 to be received in orifices 108 but such that pin 120 does not easily move through orifices 108. For example, an outer diameter of at least a portion of the pin 120 may be substantially similar to an inner diameter of the passage 108. The pin 120 may fit snuggly within the passage 108. That is, the pin 120 may fit within the passage 108 so that there is little to no gap between the pin 120 and the wall of the passage 108. The friction fit should, in general, allow a common tool such as a common hammer to be utilized to drive pin 120 into and through the orifices 108, compressing the plates 102 and securing the plates 102 against the cables 10 and 12.

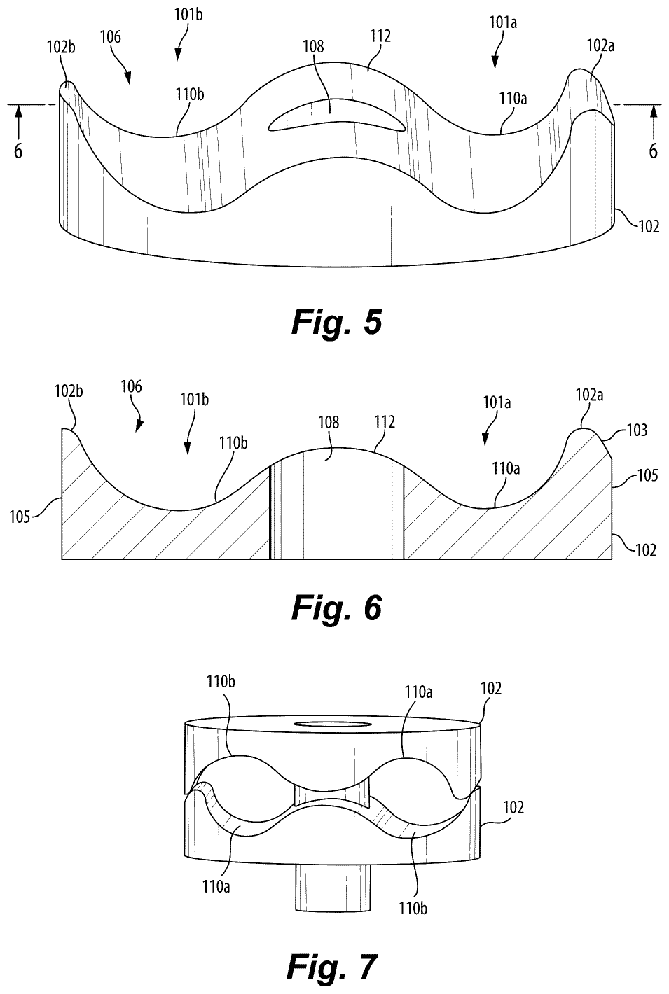

As depicted in FIGS. 5-6, the second surface 106 of each plate 102 is characterized by asymmetric side portions 101a and 101b. Side portion 101a includes an arcuate or concave channel portion 110a which is generally semi-circular having a first diameter. The cross-section of side portion 101b includes an arcuate or concave channel portion 110b which is generally semi-circular having a second diameter. According to an illustrative embodiment of the present disclosure as depicted in FIG. 6, the second diameter of the generally concave channel portion 110b may be generally larger than the first diameter of the generally concave channel portion 110a. The upper outer edge portion 102a of side portion 101a includes a generally convex semi-circular lip edge with a slopped end 103 tapering off to side surface 105 of plate 102. The upper outer edge portion 102b of side portion 101b presents a generally convex quarter-round circular edge. The center portion 112 of the second surface 106 is generally convex as shown. The surfaces of the concave channel portions 110a and 110b may be smooth. Alternatively, the surfaces of the concave channel portions 110a and 110b may include one or more imperfections providing a non-slip surface further securing the compressed conductors 10 and 12. For example, the imperfections in the surfaces of the concave channel portions 110a and 110b may be knurled to provide a series of small ridges along the surfaces.

During use the plates 102 are arranged with their second surfaces 106 opposing each other. One of the plates 102 is rotated 180 degrees with respect to the other plate 102 about an axis formed by orifice 108. In this position, the concave channel portion 110b of the upper plate 102 is positioned opposite concave channel portion 110a of the lower plate 102 forming a channel for receiving conductor 12. The concave channel portion 110a of the upper plate 102 is positioned opposite concave channel portion 110b of the lower plate 102 forming a channel for receiving conductor 10. The upper outer edge portion 102a of the upper plate 102 may abut the upper outer edge portion 102b of the lower plate 102. The upper outer edge portion 102b of the upper plate 102 may abut the upper outer edge portion 102a of the lower plate 102. When in the final resting position as depicted in FIG. 2, cables 10 and 12 are compressed between upper plate 102 and lower plate 102. Because of the arrangement of the opposing surfaces of plates 102, cable connector 100 is capable of receiving various diameter conductors and providing a secure mechanical and electrical connection. The length of the pin 120 as seen in FIG. 2 which extends from the lower plate 120 may vary, depending on the diameter of the conductors being connected.

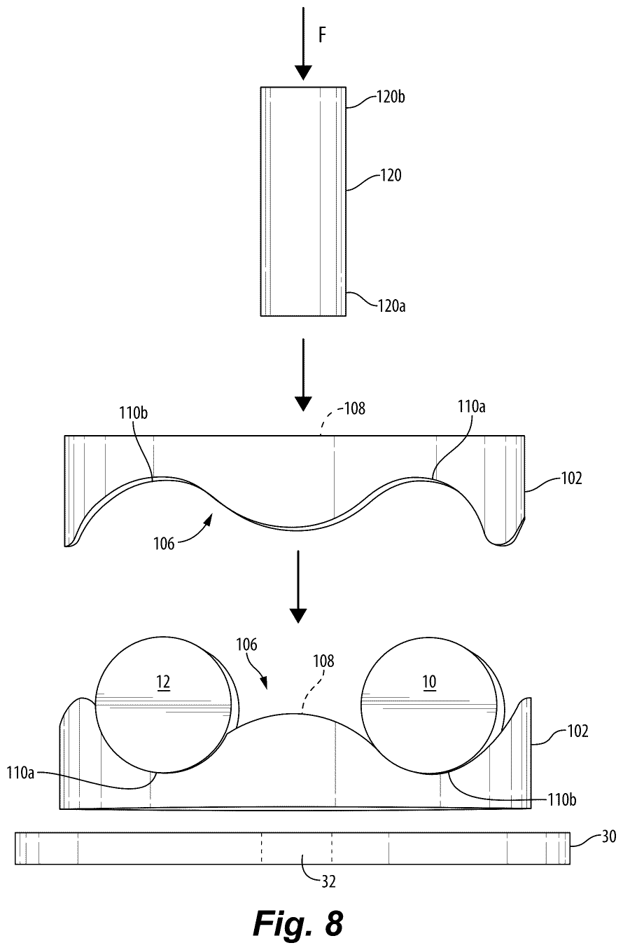

Referring to FIG. 8, to assemble the cable connector 100, the proximal end 120a of pin 120 is positioned within the orifice 108 in upper plate 102. As noted above, pin 120 may have a slight taper such that proximal end 120a has a smaller diameter than other portions of pin 120.

Accordingly, at least the proximal end 120a can be readily received in orifice 108. Conductor 10 is then positioned within one of the channel portions (e.g., channel portion 110b) and conductor 12 is positioned within the other channel portion (e.g., channel portion 110a). Upper plate 102 is then placed on top of lower plate 102. According to an embodiment of the present disclosure, a plate 30 having an orifice 32 therethrough may be provided. Orifice 32 is the same or larger in diameter than the orifices 108 and the pin 120. A common hammer may then be used to provide a force “F” to drive pin 120 through the orifices in the upper and lower plates 102. Depending on the diameter of the conductors 10, 12, pin 120 may extend through lower plate 102 (e.g., see FIG. 2). The orifice 32 in plate 30 allows the pin 120 to be driven entirely through lower plate 102 to a desired position securing conductors 10 and 12 with a sound mechanical and electrical connection. Upon completion of the process, the plate 30 may be removed and used for other processes.

Although depicted as generally circular, it will be appreciated that plates 102 may be in other shapes and configurations including, for example, square, rectangular, oblong, etc.

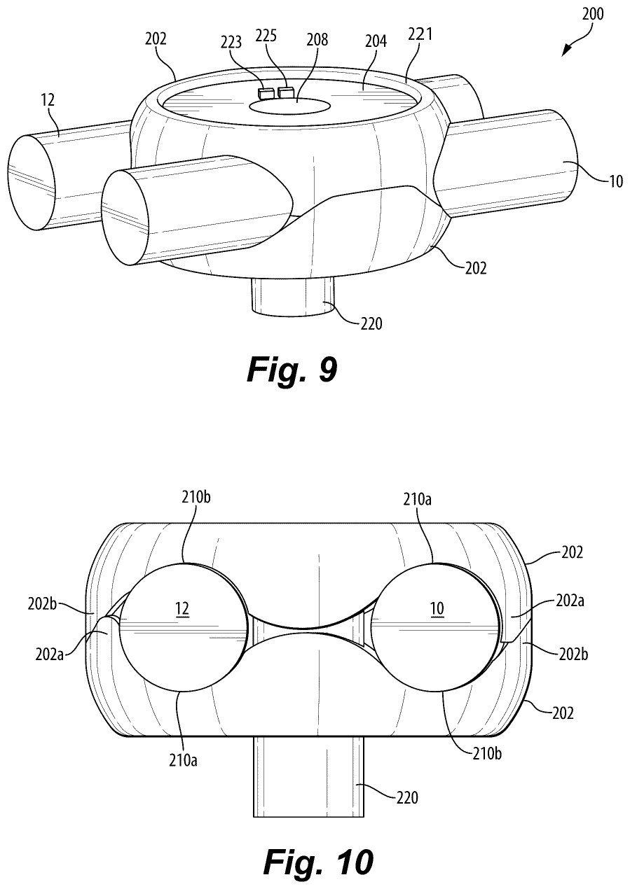

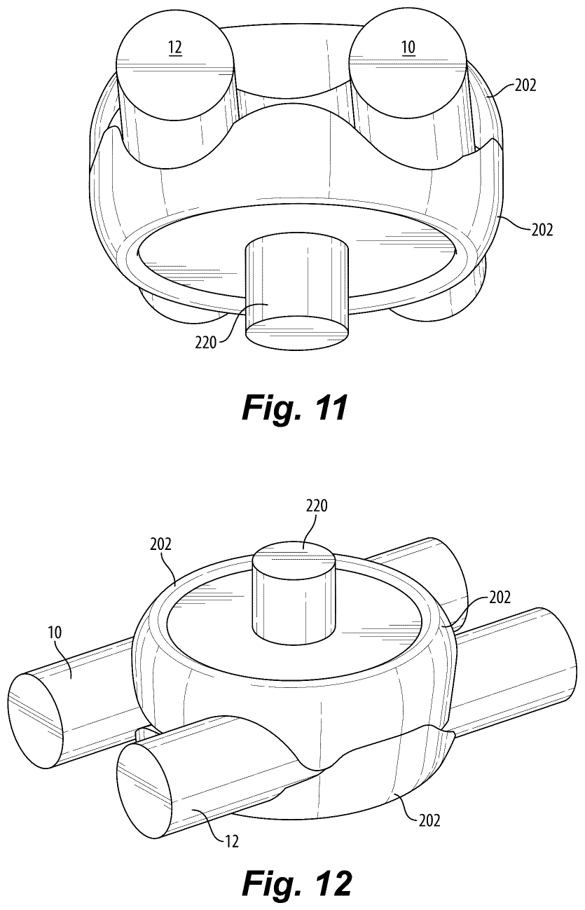

A locking plate splice connector according to another illustrative embodiment of the present disclosure is shown in FIGS. 9-16 and may be referred to generally as cable connector or connector 200. Connector 200 includes substantially similar or identical first and second plates 202 and a pin 220 which is friction fit into orifices 208 extending through the first and second plates 202. As will be described in greater detail later below, bare cables (e.g., ground cables 10, 12) are positioned between the first and second plates 202 and pin 220 is driven into the orifices 208 compressing the first and second plates against the bare cables providing a mechanical and electrical connection thereto. According to the present illustrative embodiment, the first and second plates 202 include locking members for securing the first and second plates 202 together.

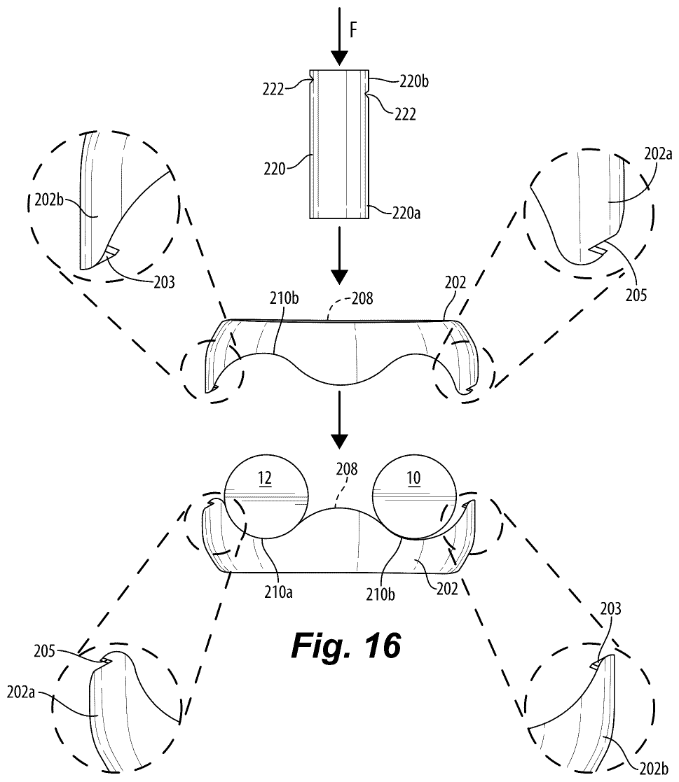

Connector 200 includes first and second plates 202 each having a first surface 204 and a second surface 206. Passages or orifices 208 extend through the centers of the first and second plates 202 and are dimensioned to receive a pin 220. According to an illustrative embodiment of the present disclosure, pin 220 is received in orifices 208 with a friction fit. Pin 220 may be tapered to allow it to be initially positioned within orifice 208. For example, pin 220 may have a slight taper from one end to the other end. Alternatively, each end of pin 220 may be tapered such that the middle portion of pin 220 is slightly larger in diameter than the end portions. Generally, pin 220 has a diameter allowing pin 220 to be received in orifices 208 but such that pin 220 does not easily move through orifices 208. For example, an outer diameter of at least a portion of the pin 220 may be substantially similar to an inner diameter of the passage 208. The pin 220 may fit snuggly within the passage 208. That is, the pin 220 may fit within the passage 208 so that there is little to no gap between the pin 220 and the wall of the passage 208. The friction fit should, in general, allow a common tool such as a common hammer to be utilized to drive pin 220 into and through the orifices 208, compressing the plates 202 against the cables 10, 12. The pin 220 may include one or more notches 222 as seen in FIG. 16 to indicate a depth to which the pin should be driven into the orifice 208 in top plate 202, depending on the size of the conductors 10 and 20 being joined.

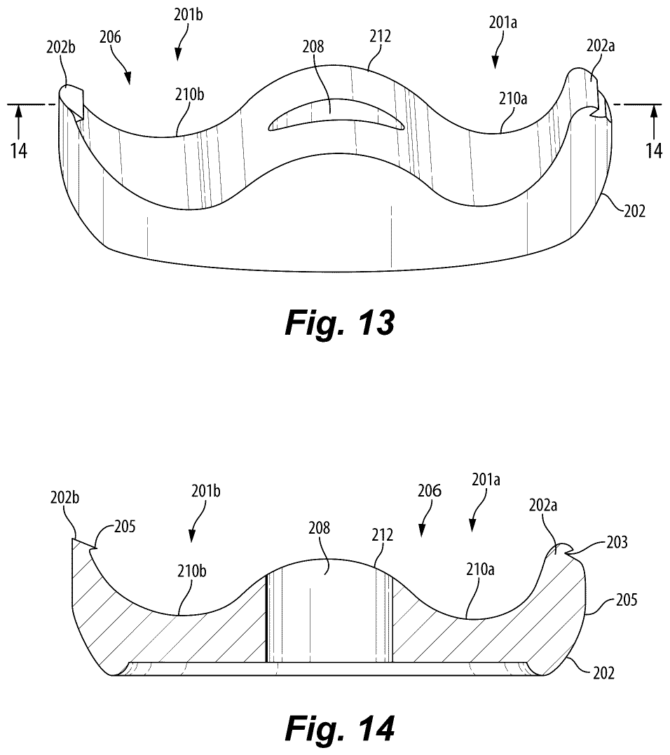

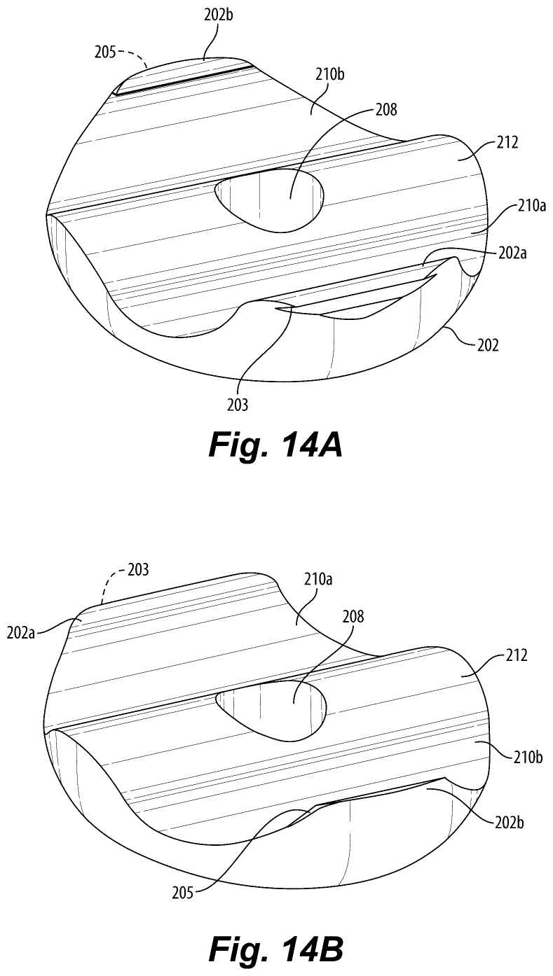

According to the present embodiment, a raised ridge or lip 221 extends around at least a portion of the outer edge of the first surface 204. The raised lip 221 creates an offset for space for the pin 220 to drive though the back surface of the plate 202. The first surface 204 may also include one or more raised indicators 223 and 225 in the vicinity of the orifice 208. The raised indicators 223 and 225 indicate a depth to which the pin 220 should be driven, depending on the size of the conductors 10 and 12 being joined. As depicted in FIGS. 13 and 14, the second surface 206 of each plate 202 is characterized by asymmetric side portions 201a and 201b. The cross-section of side portion 201a includes an arcuate or concave channel portion 210a which is generally semi-circular having a first diameter. The side portion 201b includes an arcuate or concave channel portion 210b which is generally semi-circular having a second diameter which may be the same or different from the first diameter. The surfaces of the concave channel portions 210a and 210b may be smooth. Alternatively, the surfaces of the concave channel portions 210a and 210b may include one or more imperfections providing a non-slip surface further securing the compressed conductors. For example, the imperfections in the surfaces of the concave channel portions 210a and 210b may be knurled to provide a series of small ridges along the surfaces. According to an illustrative embodiment of the present disclosure, the second diameter of the generally concave channel portion 210b may be generally larger than the first diameter of the generally concave channel portion 210a. The upper outer edge portion 202a of side portion 201a includes a generally convex semi-circular lip edge with an outwardly facing notch 203. The upper outer edge portion 202b of side portion 201b includes an inwardly facing hook 205. The center portion 212 of the second surface 206 is generally convex as shown.

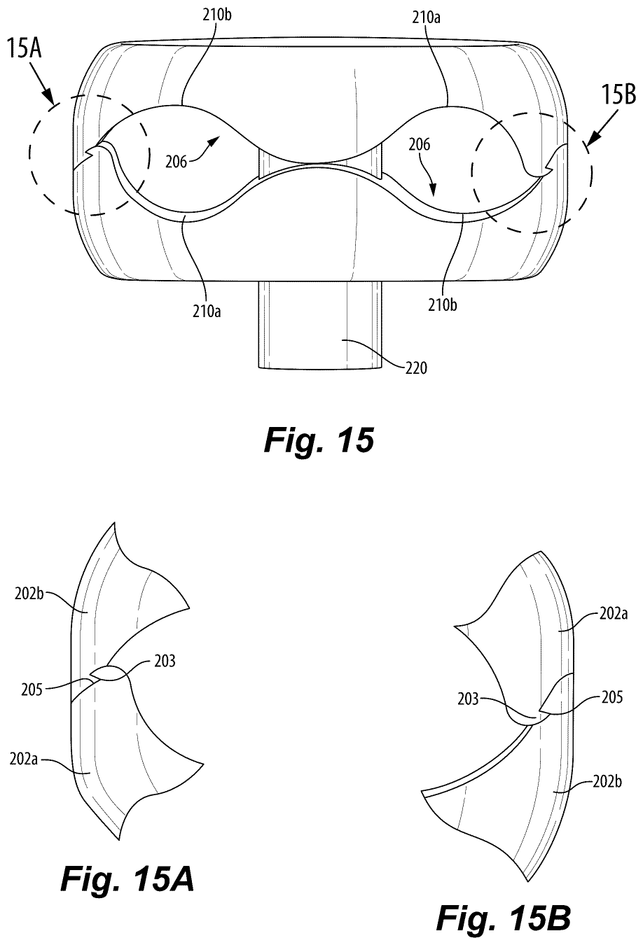

During use the plates 202 are arranged with their second surfaces 206 opposing each other. One of the plates 202 is rotated 180 degrees with respect to the other plate 202 about an axis formed by orifice 208. In this position, the concave channel portion 210b of the upper plate 202 is positioned opposite concave channel portion 210a of the lower plate 202 forming a channel for receiving conductor 12. The concave channel portion 210a of the upper plate 202 is positioned opposite concave channel portion 210b of the lower plate 202 forming a channel for receiving conductor 10. When pin 220 is driven through the orifices 208 urging upper plate 202 and lower plate 202 together, the upper outer edge portion 202a of lower plate 202 contacts the outer edge portion 202b of upper plate 202 until hook 203 engages notch 205 as seen in FIG. 15A. The upper outer edge portion 202b of lower plate 202 contacts the outer edge portion 202a of upper plate 202 until hook 205 engages notch 203 as seen in FIG. 15B. In this position, the upper and lower plates 202 are in a locked position. When in the locked position as depicted in FIGS. 9-12, cables 10 and 12 are compressed between upper plate 202 and lower plate 202.

Referring to FIG. 16, to assemble the cable connector 200, the proximal end 220a of pin 220 is positioned within the orifice 208 in upper plate 202. As noted above, pin 220 may have a slight taper such that proximal end 220a has a smaller diameter than other portions of pin 220.

Accordingly, at least the proximal end 220a can be readily received in orifice 208. Conductor 10 is then positioned within one of the channel portions (e.g., channel portion 210b) and conductor 12 is positioned within the other channel portion (e.g., channel portion 210a). Upper plate 202 is then placed on top of lower plate 202. As described above with respect to an earlier embodiment, a plate 30 having an orifice 32 therethrough may be provided, as seen in FIG. 8. Orifice 32 is the same or larger in diameter than the orifices 208 and the pin 220. A common hammer may then be used to provide a force “F” to drive pin 220 through the orifices in the upper and lower plates 202. Depending on the diameter of the conductors 10, 12, pin 220 may extend through lower plate 102. The upper plate 202 is driven down onto lower plate 202 compressing conductors 10 and 12 and until hooks 203 of the upper and lower plates 202 engage the notches 205 in the upper and lower plates 202. The orifice 32 in plate 30 allows the pin 220 to be driven entirely through to a desired position securing conductors 10 and 12 with a sound mechanical and electrical connection. Upon completion of the process, the plate 30 may be removed and used for other processes.

Although depicted as generally circular, it will be appreciated that plates 202 may be in other shapes and configurations including, for example, square, rectangular, oblong, etc.

The plates and pins described herein may be made of an electrically conductive material that has sufficient rigidity to withstand the forces applied when hammering the pins 120, 220 into the orifices 108, 208 in the plates 102, 202 to mechanically and electrically connect the conductors 10 and 12. Non-limiting examples of such electrically conductive and rigid materials include aluminum, aluminum alloys, steel, stainless steel, galvanized steel, copper and copper/brass alloys, etc. The plates 102, 202 may also have a certain degree of flexibility such that the portions of the plates 202 having the hook 203 and notch 205 connection portions are capable of flexing to engage the hooks 203 and notches 205 and are capable of returning to substantially the same positions prior to being flexed.

Certain terminology may be used in the present disclosure for ease of description and understanding. Examples include the following terminology or variations thereof: top, bottom, up, upward, upper inner, outer, outward, down, downward, upper, lower, vertical, horizontal, etc. These terms refer to directions in the drawings to which reference is being made and not necessarily to any actual configuration of the structure or structures in use and, as such, are not necessarily meant to be limiting.

As shown throughout the drawings, like reference numerals designate like or similar corresponding parts. While illustrative embodiments of the present disclosure have been described and illustrated above, it should be understood that these are exemplary of the disclosure and are not to be considered as limiting. Various portions of the described embodiments may be mixed and matched depending on a particular application. Additions, deletions, substitutions, and other modifications can be made without departing from the spirit or scope of the present disclosure. Accordingly, the present disclosure is not to be considered as limited by the foregoing description.

What is claimed is:

1. An electrical conductor splice connector comprising:
a first plate comprising,
a first pair of channels, and
an orifice extending through first plate;
a second plate comprising,
a second pair of channels, and
an orifice extending through the second plate; and
a pin dimensioned to be friction fit within the orifices extending through the first and second plates.

2. The electrical conductor splice connector according to claim 1, wherein the first and second pairs of channels are concave.

3. The electrical conductor splice connector according to claim 1, wherein a first channel of the first pair of channels has a first cross-sectional diameter.

4. The electrical conductor splice connector according to claim 3, wherein a second channel of the first pair of channels has a second cross-sectional diameter.

5. The electrical conductor splice connector according to claim 4, wherein the second cross-sectional diameter is different than the first cross-sectional diameter.

6. The electrical conductor splice connector according to claim 1, wherein the first plate and the second plate are identical.

7. The electrical conductor splice connector according to claim 1, wherein the first pair of channels are dimensioned to receive conductors of various diameters.

8. The electrical conductor splice connector according to claim 1, wherein the first plate and the second plate further comprise locking mechanisms for locking the first and second plates together.

9. The electrical conductor splice connector according to claim 8, wherein the locking mechanisms comprising hooks and notches.

10. The electrical conductor splice connector according to claim 9, wherein each plate comprises a hook and a notch.

11. The electrical conductor splice connector according to claim 10, wherein the hook of the first plate engages the notch of the second plate.

12. The electrical conductor splice connector according to claim 11, wherein the notch of the first plate engages the hook of the second plate.

13. The electrical conductor splice connector according to claim 1, wherein the pin tapers from a first end to a second end.

14. An electrical conductor splice connector comprising:
matching first and second plates, each comprising,
a pair of channels, and
an orifice extending through the plate; and
a pin dimensioned to be friction fit within the orifices extending through the first and second plates.

15. The electrical conductor splice connector according to claim 14, wherein the pair of channels are concave.

16. The electrical conductor splice connector according to claim 14, wherein a first channel of the pair of channels has a first cross-sectional diameter.

17. The electrical conductor splice connector according to claim 16, wherein a second channel of the pair of channels has a second cross-sectional diameter.

18. The electrical conductor splice connector according to claim 17, wherein the second cross-sectional diameter is different than the first cross-sectional diameter.

19. The electrical conductor splice connector according to claim 14, wherein the first plate and the second plate are identical.

20. The electrical conductor splice connector according to claim 14, wherein the pair of channels are dimensioned to receive conductors of various diameters.

21. The electrical conductor splice connector according to claim 14, wherein the matching first and second plates further comprise locking mechanisms for locking the first and second plates together.

22. The electrical conductor splice connector according to claim 21, wherein the locking mechanisms comprising hooks and notches.

23. The electrical conductor splice connector according to claim 22, wherein each plate comprises a hook and a notch.

24. The electrical conductor splice connector according to claim 23, wherein the hook of the first plate engages the notch of the second plate.

25. The electrical conductor splice connector according to claim 24, wherein the notch of the first plate engages the hook of the second plate.

26. The electrical conductor splice connector according to claim 14, wherein the pin tapers from a first end to a second end.
